(19) United States
(12) Patent Application Publication
(10) Pub. No.: US 2024/0185478 A1
(43) Pub. Date: Jun. 6, 2024

(54) Virtual Occlusion Mask Prediction Through Implicit Depth Estimation

(71) Applicant: Niantic, Inc., San Francsico, CA (US)

(72) Inventors: James Watson, London (GB); Mohamed Sayed, London (GB); Zawar Imam Qureshi, London (GB); Gabriel J. Brostow, London (GB); Sara Alexandra Gomes Vicente, London (GB); Oisin Mac Aodha, Edinburgh (GB); Michael David Firman, London (GB)

(21) Appl. No.: 18/530,189

(22) Filed: Dec. 5, 2023

Related U.S. Application Data
(60) Provisional application No. 63/430,541, filed on Dec. 6, 2022.

(51) Int. Cl. G06T 11/00; G06T 7/55; G06T 7/60

(52) U.S. Cl. CPC G06T 11/00; G06T 7/55; G06T 7/60; G06T 2207/10016; G06T 2207/20081; G06T 2207/20084

(57) ABSTRACT

A system generates augmented reality content by generating an occlusion mask via implicit depth estimation. The system receives input image(s) of a real-world environment captured by a camera assembly. The system generates a feature map from the input image(s), wherein the feature map comprises abstract features representing depth of object(s) in the real-world environment. The system generates an occlusion mask from the feature map and a depth map for the virtual object. The depth map for the virtual object indicates a depth of each pixel of the virtual object. The occlusion mask indicates pixel(s) of the virtual object that are occluded by an object in the real-world environment. The system generates the composite image based on a first input image at a current timestamp, the virtual object, and the occlusion mask. The composite image may then displayed on an electronic display.

### CROSS-REFERENCE TO RELATED APPLICATIONS

The present application claims the benefit of and priority to U.S. Provisional Application No. 63/430,541 filed on Dec. 6, 2022, which is incorporated by reference in its entirety.

### BACKGROUND

### 1. Technical Field

The subject matter described relates generally to determining an occlusion mask for adding virtual content in an augmented reality context.

### 2. Problem

When generating augmented reality content, a system generally needs to understand how to occlude and/or disocclude virtual objects within the physical objects captured in an image. Conventional systems first predict a depth map based on an image of an environment with physical objects. The depth map establishes a predicted depth of each pixel in the image. The system can then, based on the depth map, determine an occlusion mask for a virtual object to be added into the image. However, artifacts in the depth estimation step cascade down into the occlusion mask, leading to poor augmenting of the virtual objects into the environment. These deficiencies are particularly noticeable around physical object edges.

### SUMMARY

The present disclosure describes an approach to prediction of an occlusion mask from input image(s) through implicit depth estimation by an augmented reality (AR) system. An occlusion mask prediction model generally comprises a feature network that inputs real-world image(s) of an environment to output a feature map, and a mask predictor that inputs the feature map, a virtual object, and depth of the virtual object to predict the occlusion mask. The occlusion mask indicates which pixels in the virtual object are occluded by a real-world object. The system then composites the virtual object according to the occlusion mask with the real-world image.

The integration of augmented images with virtual objects that are accurately occluded by real-world elements offers numerous advantages, significantly enhancing the overall user experience. By melding real-world images with virtual objects seamlessly, users are provided with a highly immersive and visually coherent environment. This streamlined integration creates a more believable and engaging experience for users, making it easier for them to interact with the augmented-reality content. Moreover, the efficient computing methods employed to ensure rapid processing helps minimize lag time between image capture and presentation, thereby fostering a smooth, responsive, and more enjoyable augmented-reality experience for users. Consequently, these benefits amount to technological improvements to the field of augmented reality.

### BRIEF DESCRIPTION OF THE DRAWINGS

FIG. 1 illustrates a networked computing environment, according to one or more embodiments.

FIG. 2 depicts a representation of a virtual world having a geography that parallels the real world, according to one or more embodiments.

FIG. 3 depicts an exemplary game interface of a parallel reality game, according to one or more embodiments.

FIG. 4 illustrates an example architecture of an occlusion mask prediction model, according to one or more embodiments.

FIG. 5 is a flowchart describing a method of generating augmented reality content using an occlusion mask prediction model, in accordance with one or more embodiments.

FIG. 6 illustrates an example computer system suitable for use in training or applying a depth estimation model, according to one or more embodiments.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### Exemplary Location-Based Parallel Reality Gaming System

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where a scene reconstruction from image data is beneficial. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

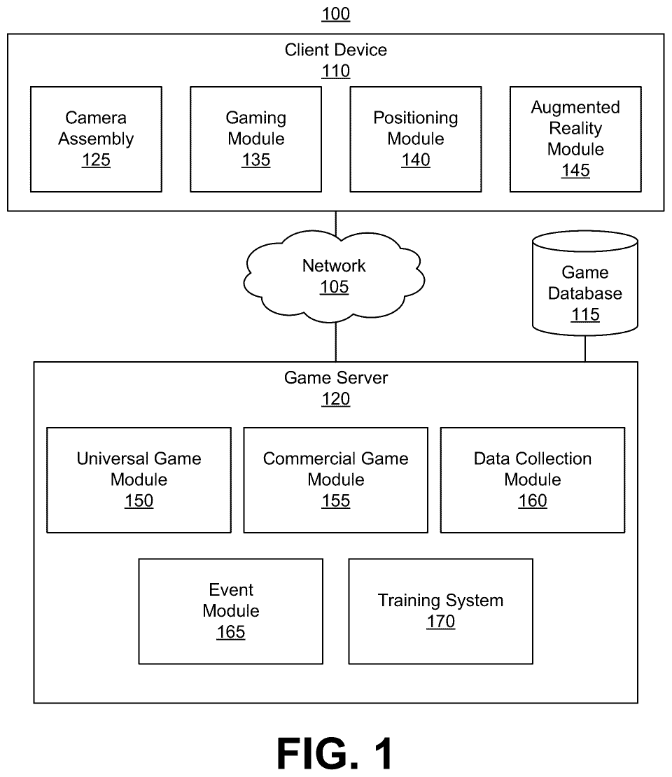

FIG. 1 illustrates a networked computing environment 100, according to one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 120 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 120.

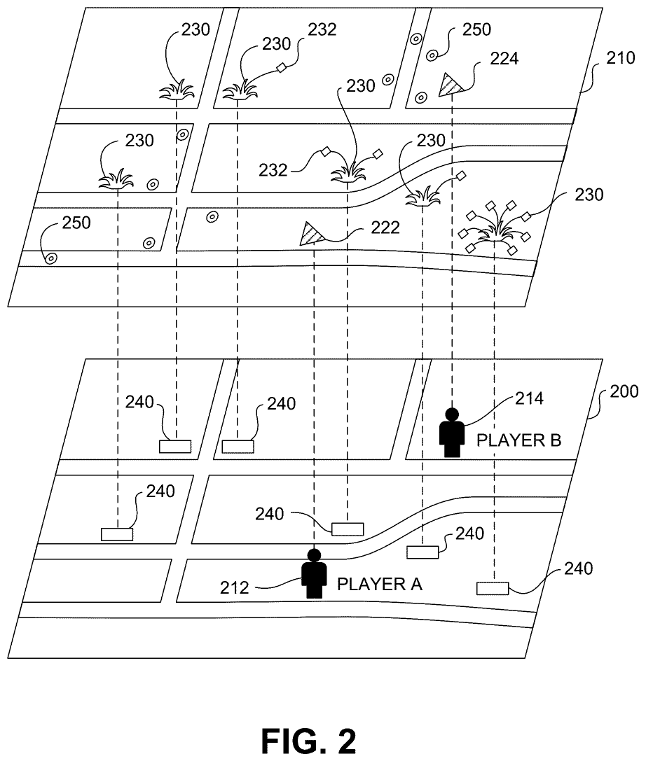

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player's position in the virtual world 210 corresponds to the player's position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player's position as the player navigates the range of geographic coordinates in the real world. Data associated with the player's position in the real world 200 is used to update the player's position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g. weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. In some embodiments, a player can turn on the camera of the mobile device to provide an augmented reality experience where real-time image data is displayed augmented with generated virtual content. The generation of the virtual content may rely in part on a 3D representation of the scene (e.g., as determined by a scene reconstruction model). Those of ordinary skill in the art, using the disclosures provided herein, should understand that various other game features can be included with the parallel reality game without deviating from the scope of the present disclosure.

In one or more embodiments, the parallel reality game may incorporate an augmented reality experience. Augmented reality generally includes generating and displaying virtual content in a real-world environment. In one or more examples, the client device 110 may be an eyewear device or another type of headset with one or more lenses that at least partially transmit light from the environment with capabilities of displaying virtual content in conjunction with the transmitted light from the real-world. In other examples, the client device 110 comprises an electronic display that presents a live feed of the camera assembly capturing a real-world environment. The client device 110 may generate virtual content that is overlaid onto the live feed. In either case, the effect is similar; there is virtual content that is presented in conjunction with real-world content. As an example, a virtual character may be generated and displayed in conjunction with the live feed from the camera assembly. The virtual character may be so generated to realistically interact with the environment. In one or more embodiments, the virtual content may be occluded and/or disoccluded by physical objects in the real-world content. To present virtual content at least partially occluded, the client device 110 generates an occlusion mask to determine which pixels of the virtual content are occluded.

Referring back FIG. 1, the networked computing environment 100 uses a client-server architecture, where a game server 120 communicates with a client device 110 over a network 105 to provide a parallel reality game to players at the client device 110. The networked computing environment 100 also may include other external systems such as sponsor/advertiser systems or business systems. Although only one client device 110 is illustrated in FIG. 1, any number of clients 110 or other external systems may be connected to the game server 120 over the network 105. Furthermore, the networked computing environment 100 may contain different or additional elements and functionality may be distributed between the client device 110 and the server 120 in a different manner than described below.

A client device 110 can be any portable computing device that can be used by a player to interface with the game server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the game server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

The client device 110 communicates with the game server 120 providing the game server 120 with sensory data of a physical environment. The client device 110 includes a camera assembly 125 that captures image data in two dimensions of a scene in the physical environment where the client device 110 is. In the embodiment shown in FIG. 1, each client device 110 includes software components such as a gaming module 135 and a positioning module 140. The client device 110 also includes an augmented reality module 145. The client device 110 may include various other input/output devices for receiving information from and/or providing information to a player. Example input/output devices include a display screen, a touch screen, a touch pad, data entry keys, speakers, and a microphone suitable for voice recognition. The client device 110 may also include other various sensors for recording data from the client device 110 including but not limited to movement sensors, accelerometers, gyroscopes, other inertial measurement units (IMUs), barometers, positioning systems, thermometers, light sensors, etc. The client device 110 can further include a network interface for providing communications over the network 105. A network interface can include any suitable components for interfacing with one more networks, including for example, transmitters, receivers, ports, controllers, antennas, or other suitable components.

The camera assembly 125 captures image data of a scene of the environment where the client device 110 is in. The camera assembly 125 may utilize a variety of varying photo sensors with varying color capture ranges at varying capture rates. The camera assembly 125 may contain a wide-angle lens or a telephoto lens. The camera assembly 125 may be configured to capture single images or video as the image data. Additionally, the orientation of the camera assembly 125 could be parallel to the ground with the camera assembly 125 aimed at the horizon. The camera assembly 125 captures image data and shares the image data with the computing device on the client device 110. The image data can be appended with metadata describing other details of the image data including sensory data (e.g. temperature, brightness of environment) or capture data (e.g. exposure, warmth, shutter speed, focal length, capture time, etc.). The camera assembly 125 can include one or more cameras which can capture image data. In one instance, the camera assembly 125 comprises one camera and is configured to capture monocular image data. In another instance, the camera assembly 125 comprises two cameras and is configured to capture stereoscopic image data. In various other implementations, the camera assembly 125 comprises a plurality of cameras each configured to capture image data.

The gaming module 135 provides a player with an interface to participate in the parallel reality game. The game server 120 transmits game data over the network 105 to the client device 110 for use by the gaming module 135 at the client device 110 to provide local versions of the game to players at locations remote from the game server 120. The game server 120 can include a network interface for providing communications over the network 105. A network interface can include any suitable components for interfacing with one more networks, including for example, transmitters, receivers, ports, controllers, antennas, or other suitable components.

The gaming module 135 executed by the client device 110 provides an interface between a player and the parallel reality game. The gaming module 135 can present a user interface on a display device associated with the client device 110 that displays a virtual world (e.g. renders imagery of the virtual world) associated with the game and allows a user to interact in the virtual world to perform various game objectives. In some other embodiments, the gaming module 135 presents augmented reality content generated by augmented reality module 145.

The gaming module 135 can also control various other outputs to allow a player to interact with the game without requiring the player to view a display screen. For instance, the gaming module 135 can control various audio, vibratory, or other notifications that allow the player to play the game without looking at the display screen. The gaming module 135 can access game data received from the game server 120 to provide an accurate representation of the game to the user. The gaming module 135 can receive and process player input and provide updates to the game server 120 over the network 105. The gaming module 135 may also generate and/or adjust game content to be displayed by the client device 110. For example, the gaming module 135 may generate a virtual element based on depth information.

The positioning module 140 can be any device or circuitry for monitoring the position of the client device 110. For example, the positioning module 140 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 140 may further include various other sensors that may aid in accurately positioning the client device 110 location.

As the player moves around with the client device 110 in the real world, the positioning module 140 tracks the position of the player and provides the player position information to the gaming module 135. The gaming module 135 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 135 can provide player position information to the game server 120 over the network 105. In response, the game server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g. to update player position in the virtual world). In addition, any location information associated with players will be stored and maintained in a manner to protect player privacy.

The augmented reality module 145 generates augmented reality content for display by the gaming module 135. In some embodiments, the augmented reality content comprises image data from the real world (e.g., captured by the camera assembly 125) augmented with virtual elements from the parallel reality game. In these embodiments, the augmented reality module 145 may generate virtual content and/or adjust virtual content according to other information received from other components of the client device 110. In one or more embodiments, the augmented reality module 145 generates the augmented reality content by generating an occlusion mask for a virtual object to be added into the real-world environment as captured by the camera assembly 125. The occlusion mask is a bit map that determines whether a pixel of the virtual object is occluded or visible by real-world objects in the image data. The augmented reality module 145 may generate the occlusion mask using an occlusion mask prediction model. The augmented reality module 145 may further composite the augmented reality image using the occlusion mask and the image data.

The game server 120 can be any computing device and can include one or more processors and one or more computer-readable storage media. The computer-readable storage media can store instructions which cause the processor to perform operations. The game server 120 can include or can be in communication with a game database 115. The game database 115 stores game data used in the parallel reality game to be served or provided to the client(s) 120 over the network 105.

The game data stored in the game database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the game database 115 can be populated either offline or in real time by system administrators and/or by data received from users/players of the system 100, such as from a client device 110 over the network 105.

The game server 120 can be configured to receive requests for game data from a client device 110 (for instance via remote procedure calls (RPCs)) and to respond to those requests via the network 105. For instance, the game server 120 can encode game data in one or more data files and provide the data files to the client device 110. In addition, the game server 120 can be configured to receive game data (e.g. player positions, player actions, player input, etc.) from a client device 110 via the network 105. For instance, the client device 110 can be configured to periodically send player input and other updates to the game server 120, which the game server 120 uses to update game data in the game database 115 to reflect any and all changed conditions for the game.

In the embodiment shown, the server 120 includes a universal game module 150, a commercial game module 155, a data collection module 160, an event module 165, and a training system 170. As mentioned above, the game server 120 interacts with a game database 115 that may be part of the game server 120 or accessed remotely (e.g., the game database 115 may be a distributed database accessed via the network 105). In other embodiments, the game server 120 contains different and/or additional elements. In addition, the functions may be distributed among the elements in a different manner than described. For instance, the game database 115 can be integrated into the game server 120.

The universal game module 150 hosts the parallel reality game for all players and acts as the authoritative source for the current status of the parallel reality game for all players. As the host, the universal game module 150 generates game content for presentation to players, e.g., via their respective client devices 110. The universal game module 150 may access the game database 115 to retrieve and/or store game data when hosting the parallel reality game. The universal game module 150 also receives game data from client device 110 (e.g. depth information, player input, player position, player actions, landmark information, etc.) and incorporates the game data received into the overall parallel reality game for all players of the parallel reality game. The universal game module 150 can also manage the delivery of game data to the client device 110 over the network 105. The universal game module 150 may also govern security aspects of client device 110 including but not limited to securing connections between the client device 110 and the game server 120, establishing connections between various client device 110, and verifying the location of the various client device 110.

The commercial game module 155, in embodiments where one is included, can be separate from or a part of the universal game module 150. The commercial game module 155 can manage the inclusion of various game features within the parallel reality game that are linked with a commercial activity in the real world. For instance, the commercial game module 155 can receive requests from external systems such as sponsors/advertisers, businesses, or other entities over the network 105 (via a network interface) to include game features linked with commercial activity in the parallel reality game. The commercial game module 155 can then arrange for the inclusion of these game features in the parallel reality game.

The game server 120 can further include a data collection module 160. The data collection module 160, in embodiments where one is included, can be separate from or a part of the universal game module 150. The data collection module 160 can manage the inclusion of various game features within the parallel reality game that are linked with a data collection activity in the real world. For instance, the data collection module 160 can modify game data stored in the game database 115 to include game features linked with data collection activity in the parallel reality game. The data collection module 160 can also analyze and data collected by players pursuant to the data collection activity and provide the data for access by various platforms.

The event module 165 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The training system 170 trains models for use by the client device 110. For example, the training system 170 may train and generate the occlusion mask prediction model that may be provided to the client device 110 for generating occlusion masks based on input image data. The training system 170 receives training data to train the models. To train the occlusion mask prediction model, as an example, the training system 170 may receive image data, depth data corresponding to the image data, camera poses, camera intrinsic parameters, or some combination thereof. In training of the models, the training system 170 generally utilizes a loss function to evaluate the model. The training system 170 feeds the training data into the model and adjusts parameters of the model to minimize the loss of the model. In some embodiments, the training system 170 may train various steps asynchronously. The general process above describes a supervised training algorithm. In one or more embodiments, unsupervised training entails learning of patterns in the input training data without the supervision of ground truth labels.

The network 105 can be any type of communications network, such as a local area network (e.g. intranet), wide area network (e.g. Internet), or some combination thereof. The network can also include a direct connection between a client device 110 and the game server 120. In general, communication between the game server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Exemplary Game Interface

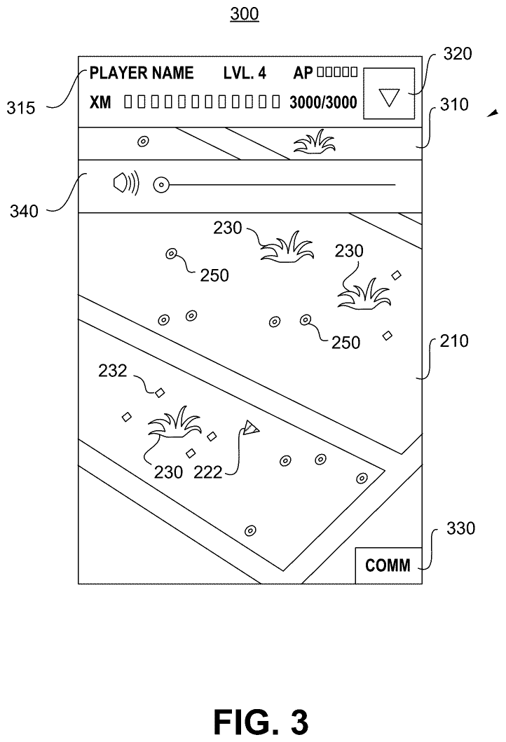

FIG. 3 depicts one embodiment of a game interface 300 that can be presented on a display of a client 120 as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 120 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

In some embodiments, the game interface 300 may be an augmented reality experience. The game interface 300 may display augmented reality content, e.g., the real-world environment (e.g., as captured by the camera assembly 125) augmented with virtual content (e.g., as generated by the augmented reality module 145). In the example shown in FIG. 3, the ground environment is captured by the camera assembly. Overlaid on the real-world image are virtual objects (e.g., the virtual elements 230, the virtual items 232, the virtual energy 250, virtual characters, etc.). The virtual objects may be generated and positioned based on the 3D representation generated by the scene reconstruction model. For example, a virtual object may be dropped from the sky and bounce on surfaces in the real-world object based on the 3D representation generated by the scene reconstruction model.

Those of ordinary skill in the art, using the disclosures provided herein, will appreciate that numerous game interface configurations and underlying functionalities will be apparent in light of this disclosure. The present disclosure is not intended to be limited to any one particular configuration.

### Occlusion Mask Prediction Model Architecture

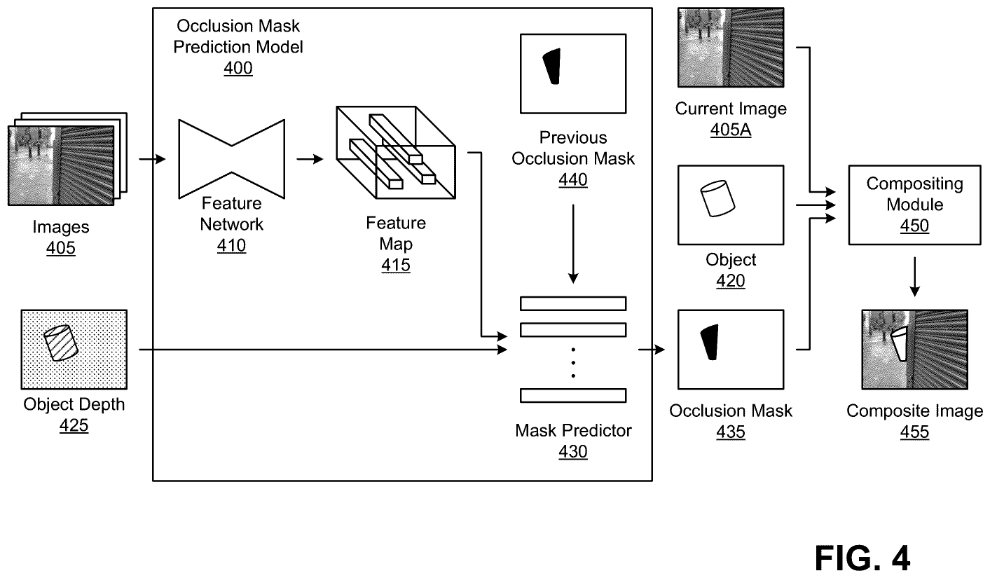

FIG. 4 illustrates an example architecture of an occlusion mask prediction model 400, according to one or more embodiments. In the embodiment shown in FIG. 4, the occlusion mask prediction model 400 comprises the following components: a feature network 410 and a mask predictor 430. In other embodiments, the occlusion mask prediction model 400 may comprise additional, fewer, or different components than those listed herein. The occlusion mask prediction model 400 inputs images 405 and object depth 425, and outputs an occlusion mask 435 for a current image 405A. The compositing module 450 composites the current image 405A with object 420 according to the occlusion mask 435 to generate the composite image 455.

The feature network 410 inputs the images 405 to output a feature map 415 of the images. The feature map 415 encodes abstract features representing depth of one or more objects. The feature map 415 may comprise concatenated features across the images 405. The feature network 410 may be a machine-learning model, e.g., with a neural network architecture. Accordingly, the feature network 410 may be trained with a training data set (e.g., the training system 170) of input images. In some embodiments, the feature network 410 may be trained in a supervised manner with ground truth depth maps corresponding to the input images. In other embodiments, the feature network 410 may be trained in an unsupervised manner, learning abstract depth features based on the training image data.

In one or more embodiments, the feature map 415 is of the same dimensionality as the input images. In one example implementation, a single two-dimensional image is input into the feature network 410 which correspondingly outputs the feature map 415 as two-dimensional. In other example implementations, the feature network 410 inputs a series of input images and output a feature map 415 as a matrix of concatenated features across the images. For example, the feature map 415 may have a layer of features corresponding to each input image. In other embodiments, the feature map 415 may be of different dimensionality as the input images. For example, the feature map 415 may be of lower dimensionality, which encodes the abstract depth features of the input images.

The mask predictor 430 inputs the feature map 415 and the object depth 425 to generate the occlusion mask 435. In some embodiments, the mask predictor 430 further inputs the previous occlusion mask 440 for temporal smoothing. The previous occlusion mask 440 refers to a previously generated occlusion mask for an image having an earlier timestamp than the current image 405A. In general, the mask predictor 430 predicts per-pixel occlusion of the virtual object, based on the depth of the virtual object and the feature map 415. The mask predictor 430 may be a machine-learning model, e.g., with a multi-layer perceptron, recurrent neural network, convolutional neural network, autoencoder, other deep-learning neural network, decision trees, or another type of machine-learning architecture. In some embodiments, the mask predictor 430 may input multiple previous occlusion masks 440. The mask predictor 430 may include a hyperparameter for temporal smoothing, that may be tuned to find a balance with enforcing consistency with the previous occlusion masks and predicting the occlusion mask 435 based on the feature map 415. The occlusion mask 435 may be a binary representation of whether a pixel of the virtual object is occluded (e.g., represented by the “0” value) or in view (e.g., represented by the “1” value).

The compositing module 450 composites the composite image 455 based on the current image 405A, the object 420, and the occlusion mask 435. The compositing module 450 may determine a portion of the object 420 that is in view by applying the occlusion mask 435 to the object 420. In some example implementations, the occlusion mask 435 in the binary representation determines which pixels of the object 420 to retain or to remove. If a pixel in the occlusion mask has the occluded value (e.g., “0” value), then the pixel of the object is removed. Contrarily, if a pixel in the occlusion mask has the in-view value (e.g., “1” value), then the pixel of the object is retained. The portion of the object 420 that is in view may then be in-painted into the current image 405A. In other example implementations, the compositing module 450 may determine a complementary mask to the occlusion mask 435, with opposing values at each pixel. The compositing module 450 applies the complementary mask to the current image 405A and the occlusion mask 435 to the object 420, then combines the two to form the composite image.

In one or more additional embodiments, when placing two or more virtual objects, the occlusion mask prediction model 400 may generate separate occlusion masks for each virtual object. The mask prediction model 400 may apply the mask predictor 430 in parallel to each virtual object's depth map to determine an occlusion mask specific to the virtual object. In other embodiments, the occlusion mask prediction model 400 may generate a single occlusion mask for all the virtual objects. The compositing module 450 may further stack the virtual objects into a single image based on their depth maps. For example, if two virtual objects at least partially overlap, and if the first virtual object is at a further depth than the second virtual object, then the compositing module 450 places the second virtual object on top of the first virtual object, i.e., the second virtual object at least partially occludes the first virtual object.

### Exemplary Methods

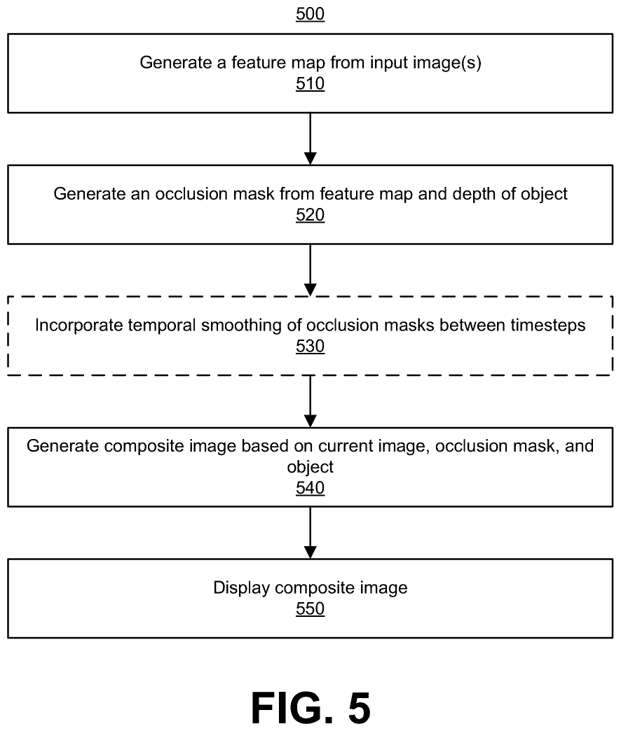

FIG. 5 is a flowchart describing a method 500 of generating augmented reality content, in accordance with one or more embodiments. The method 500 is described as being performed by a client device (e.g., the client device 110). However, some or all of the steps may be performed by other entities and/or components. In addition, some embodiments may perform the steps in parallel, perform the steps in different orders, or perform different steps. The client device generates a composite image including a virtual object at an object depth added into a real-world image.

The client device generates 510 a feature map from one or more input images. The client device may utilize a feature network that inputs the input images to output the feature map. The feature map may be of the same resolution as the input images, e.g., L×W pixels. In other embodiments, the feature map may be a matrix comprising features across multiple input images. The client device may generate the feature map by applying a feature network (e.g., the feature network 410 of FIG. 4). The feature network may be previously trained to predict abstract depth features from input images.

The client device generates 520 an occlusion mask from the feature map and the depth of the object. The client device may utilize a mask predictor that inputs the feature map and the depth of the object to output the occlusion mask. The occlusion mask is a map, wherein each pixel indicates whether the virtual object is occluded or visible, based on physical objects in the image. In some embodiments, the client device employs a mask prediction model to determine the occlusion mask (e.g., the mask predictor 430 of FIG. 4).

The client device may incorporate 530 temporal smoothing of occlusion masks between timesteps. The client device may incorporate the temporal smoothing by adding the previous step(s)'s occlusion mask to the input of the mask predictor.

The client device generates 540 a composite image based on the current image, the occlusion mask, and the object. The compositing may augment the current image with the object based on the occlusion mask. For example, the compositing relies on an aggregation function for each pixel. If the occlusion mask indicates the virtual object is visible, then the pixel in the composite image is the virtual object. If the occlusion mask indicates that the virtual object is occluded, then the pixel in the composite image is the real-world physical object in the current image.

The client device displays 550 the composite image, e.g., on an electronic display. The client device may iteratively display composite images to animate virtual objects in the real-world environment. For example, the client device may capture video of the real-world environment as a virtual object is placed into the live video feed. At each frame, the client device may generate the composite image composited with the virtual object. In some embodiments, the client device may store the composite image in a computer-readable storage medium for later utilization of the composite image. For example, the composited image may be printed out into a physical copy. In another example, the composited images may be displayed on a client device at a subsequent time.

### Example Computing System

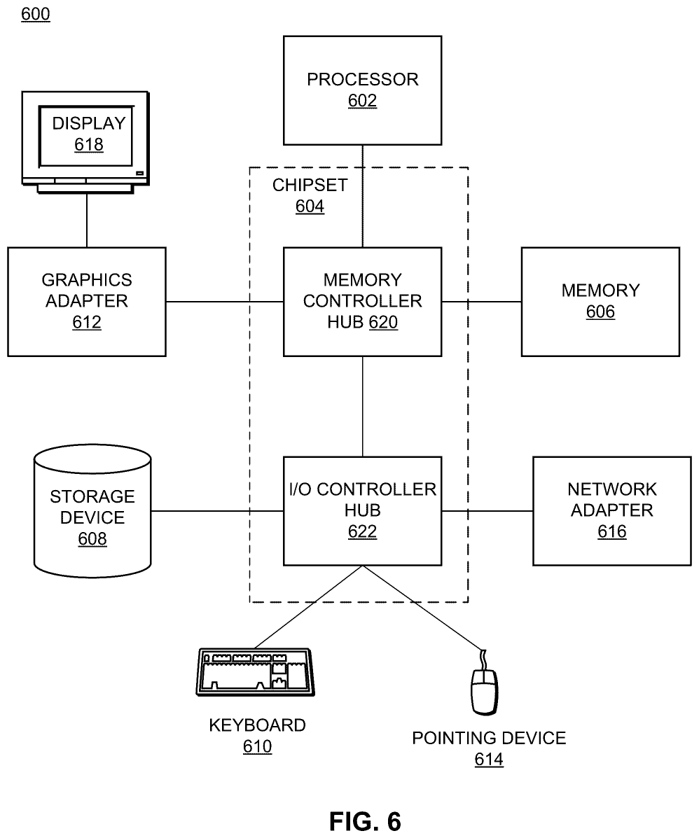

FIG. 6 is an example architecture of a computing device, according to an embodiment. Although FIG. 6 depicts a high-level block diagram illustrating physical components of a computer used as part or all of one or more entities described herein, in accordance with an embodiment, a computer may have additional, less, or variations of the components provided in FIG. 6. Although FIG. 6 depicts a computer 600, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 6 are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O hub 622. In another embodiment, the memory 606 is coupled directly to the processor 602 instead of the chipset 604. In some embodiments, the computer 600 includes one or more communication buses for interconnecting these components. The one or more communication buses optionally include circuitry (sometimes called a chipset) that interconnects and controls communications between system components.

The storage device 608 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 608 can also be referred to as persistent memory. The pointing device 614 may be a mouse, track ball, or other type of pointing device, and is used in combination with the keyboard 610 to input data into the computer 600. The graphics adapter 612 displays images and other information on the display 618. The network adapter 616 couples the computer 600 to a local or wide area network.

The memory 606 holds instructions and data used by the processor 602. The memory 606 can be non-persistent memory, examples of which include high-speed random-access memory, such as DRAM, SRAM, DDR RAM, ROM, EEPROM, flash memory.

As is known in the art, a computer 600 can have different and/or other components than those shown in FIG. 6. In addition, the computer 600 can lack certain illustrated components. In one embodiment, a computer 600 acting as a server may lack a keyboard 610, pointing device 614, graphics adapter 612, and/or display 618. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

### ADDITIONAL CONSIDERATIONS

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for verifying an account with an on-line service provider corresponds to a genuine business. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

In general, machine-learning entails computer systems learning patterns and representations of data from training data sets. This may be achieved through mathematical models, algorithms, and statistical methods. The machine-learning algorithms entail performing one or more non-mathematical operations including, but not limited to, data collection, data transformation, data storage, data processing, data integration, data querying, data analysis, data visualization, data modeling, etc. These algorithms also are innately complex with sheer numerosity of parameters that render them practically unperformable by human minds. In one or more example implementations, the inputs may include up to 10, 100, one thousand, ten thousand, one hundred thousand, one million, ten million, one hundred million, one billion, or an even greater number of inputs. The parameters in the models may include up to one million, one billion, one trillion, or an even greater number of parameters. The training data set may include one thousand, ten thousand, one hundred thousand, one million, ten million, one hundred million, one billion, or an even greater number of training samples.

What is claimed is:

1. A computer-implemented method for generating a composite image including a virtual object placed in an image of a real-world environment, the method comprising:
receiving one or more input images captured by a camera assembly of a client device of the real-world environment;
generating a feature map from the one or more input images, wherein the feature map comprises abstract features representing depth of one or more objects in the real-world environment;
generating an occlusion mask from the feature map and a depth map for the virtual object, wherein the depth map for the virtual object indicates a depth of each pixel of the virtual object, and wherein the occlusion mask indicates one or more pixels of the virtual object that are occluded by an object in the real-world environment;
generating the composite image based on a first input image at a current timestamp, the virtual object, and the occlusion mask; and
storing the composite image for subsequent display on an electronic display of the client device.

2. The computer-implemented method of claim 1, wherein the one or more input images are frames from video data captured by the camera assembly.

3. The computer-implemented method of claim 1, wherein a dimensionality of the feature map is the same as a dimensionality of the one or more input images.

4. The computer-implemented method of claim 3, wherein the feature map is a matrix comprising features across a plurality of input images.

5. The computer-implemented method of claim 1, wherein generating the feature map from the one or more input images comprises applying a trained feature network to the one or more input features to generate the feature map.

6. The computer-implemented method of claim 5, wherein the trained feature network is a neural network.

7. The computer-implemented method of claim 1, wherein generating the occlusion mask from the feature map and the depth map for the virtual object comprises applying a mask predictor to the feature map and the depth map for the virtual object to generate the occlusion mask.

8. The computer-implemented method of claim 7, wherein the mask predictor is a multi-layer perceptron.

9. The computer-implemented method of claim 1, wherein generating the occlusion mask comprises performing temporal smoothing with a previous occlusion mask generated for a second input image at a prior timestamp before the current timestamp.

10. The computer-implemented method of claim 1, wherein generating the composite image comprises:
applying the occlusion mask to the virtual object to determine a portion of the virtual object that is in view; and
placing the portion of the virtual object into the first input image to generate the composite image.

11. The computer-implemented method of claim 1, wherein the occlusion mask is generated further based on a depth map for a second virtual object, and wherein the composite image further includes the second virtual object.

12. A non-transitory computer-readable storage medium storing instructions for generating a composite image including a virtual object placed in an image of a real-world environment, the instructions that, when executed by a computer processor, cause the computer processor to perform operations comprising:
receiving one or more input images captured by a camera assembly of a client device of the real-world environment;
generating a feature map from the one or more input images, wherein the feature map comprises abstract features representing depth of one or more objects in the real-world environment;
generating an occlusion mask from the feature map and a depth map for the virtual object, wherein the depth map for the virtual object indicates a depth of each pixel of the virtual object, and wherein the occlusion mask indicates one or more pixels of the virtual object that are occluded by an object in the real-world environment;
generating the composite image based on a first input image at a current timestamp, the virtual object, and the occlusion mask; and
storing the composite image for subsequent display on an electronic display of the client device.

13. The non-transitory computer-readable storage medium of claim 12, wherein the one or more input images are frames from video data captured by the camera assembly.

14. The non-transitory computer-readable storage medium of claim 12, wherein a dimensionality of the feature map is the same as a dimensionality of the one or more input images.

15. The non-transitory computer-readable storage medium of claim 14, wherein the feature map is a matrix comprising features across a plurality of input images.

16. The non-transitory computer-readable storage medium of claim 12, wherein generating the feature map from the one or more input images comprises applying a trained feature network to the one or more input features to generate the feature map.

17. The non-transitory computer-readable storage medium of claim 12, wherein generating the occlusion mask from the feature map and the depth map for the virtual object comprises applying a mask predictor to the feature map and the depth map for the virtual object to generate the occlusion mask.

18. The non-transitory computer-readable storage medium of claim 12, wherein generating the occlusion mask comprises performing temporal smoothing with a previous occlusion mask generated for a second input image at a prior timestamp before the current timestamp.

19. The non-transitory computer-readable storage medium of claim 12, wherein generating the composite image comprises:
applying the occlusion mask to the virtual object to determine a portion of the virtual object that is in view; and
placing the portion of the virtual object into the first input image to generate the composite image.

20. The non-transitory computer-readable storage medium of claim 12, wherein the occlusion mask is generated further based on a depth map for a second virtual object, and wherein the composite image further includes the second virtual object.

21. A system for generating a composite image including a virtual object placed in an image of a real-world environment comprising:
a computer processor; and
a non-transitory computer-readable storage medium storing instructions, the instructions that, when executed by the computer processor, cause the computer processor to perform operations comprising:
receiving one or more input images captured by a camera assembly of a client device of the real-world environment;
generating a feature map from the one or more input images, wherein the feature map comprises abstract features representing depth of one or more objects in the real-world environment;
generating an occlusion mask from the feature map and a depth map for the virtual object, wherein the depth map for the virtual object indicates a depth of each pixel of the virtual object, and wherein the occlusion mask indicates one or more pixels of the virtual object that are occluded by an object in the real-world environment;
generating the composite image based on a first input image at a current timestamp, the virtual object, and the occlusion mask; and
storing the composite image for subsequent display on an electronic display of the client device.
